(19) United States
(12) Patent Application Publication
(10) Pub. No.: US 2009/0106312 A1
(43) Pub. Date: Apr. 23, 2009

(54) USER FUNCTION FEEDBACK METHOD AND SYSTEM

(76) Inventors: Franklin Charles Breslau, Teaneck, NJ (US); Robert J. Torres, Colleyville, TX (US)

Correspondence Address: SCHMEISER, OLSEN & WATTS, 22 CENTURY HILL DRIVE, SUITE 302, LATHAM, NY, 12110, US

(21) Appl. No.: 11/875,978

(22) Filed: Oct. 22, 2007

(51) Int. Cl. G06F 17/30

(52) U.S. Cl. 707/104.1; 707/E17.009

(57) ABSTRACT

A feedback method and system. The method includes includes enabling, for a first user, access to a computing system. The computing system enables a feedback software application. The computing system enables access to a first software application. The computing system retrieves a profile associated with the first software application, the first user, and a first work type being performed by the first user. The feedback software application monitors user functions associated with the first user, the first software application, and the first work type being performed by the first user. The feedback software application analyzes the user functions with respect to the profile. The feedback software application generates an analysis report comprising results of the analyzing. The computing system presents to the first user, the first analysis report.

### FIELD OF THE INVENTION

The present invention relates to a method and associated system for monitoring computer user functions and providing feedback associated with the user functions.

### BACKGROUND OF THE INVENTION

Creating data objects typically comprises a complicated and inefficient process with little flexibility. A user creating data objects may view reading materials that specify how to help streamline the process. The reading materials are not associated with the user. Accordingly, there exists a need in the art to overcome at least some of the deficiencies and limitations described herein above.

### SUMMARY OF THE INVENTION

The present invention provides a feedback method comprising:

enabling, by a computing system for a first user, access to said computing system, wherein said computing system comprises a memory system, wherein said memory system comprises a first plurality of profiles, a feedback software application, and a plurality of software applications, and wherein each profile of said first plurality of profiles is associated with said first user and various types of work to be performed by said first user;

enabling, by said computing system, said feedback software application;

enabling, by said computing system, access to a first software application of said plurality of software applications;

retrieving, by said computing system from said memory system, a first profile of said first plurality of profiles, said first profile associated with said first software application, said first user, and a first work type, said first work type being performed by said first user;

monitoring, by said feedback software application, first user functions associated with said first user, said first software application, and said first work type being performed by said first user;

analyzing, by said feedback software application, said first user functions with respect to said first profile;

generating in response to said analyzing said first user functions with respect to said first profile, by said feedback software application, a first analysis report comprising results of said analyzing said first user functions with respect to said first profile; and

presenting, by said computing system to said first user, said first analysis report.

The present invention provides a computing system comprising a processor coupled to a computer-readable memory unit, said memory unit comprising a first plurality of profiles, a feedback software application, a plurality of software applications, and instructions that when executed by the processor implement a feedback method, each profile of said first plurality of profiles associated with a first user and various types of work to be performed by said first user, said method comprising:

enabling, by said computing system for said first user, access to said computing system;

enabling, by said computing system, said feedback software application;

enabling, by said computing system, access to a first software application of said plurality of software applications;

retrieving, by said computing system from said memory system, a first profile of said first plurality of profiles, said first profile associated with said first software application, said first user, and a first work type, said first work type being performed by said first user;

monitoring, by said feedback software application, first user functions associated with said first user, said first software application, and said first work type being performed by said first user;

analyzing, by said feedback software application, said first user functions with respect to said first profile;

generating in response to said analyzing said first user functions with respect to said first profile, by said feedback software application, a first analysis report comprising results of said analyzing said first user functions with respect to said first profile; and

presenting, by said computing system to said first user, said first analysis report.

The present invention provides a computer program product, comprising a computer readable medium comprising a computer readable program code embodied therein, said computer readable program code adapted to implement a feedback method within a computing system, said method comprising:

enabling, by said computing system for a first user, access to said computing system, wherein said computing system comprises a memory system, wherein said memory system comprises a first plurality of profiles, a feedback software application, and a plurality of software applications, and wherein each profile of said first plurality of profiles is associated with said first user and various types of work to be performed by said first user;

enabling, by said computing system, said feedback software application;

enabling, by said computing system, access to a first software application of said plurality of software applications;

retrieving, by said computing system from said memory system, a first profile of said first plurality of profiles, said first profile associated with said first software application, said first user, and a first work type, said first work type being performed by said first user;

monitoring, by said feedback software application, first user functions associated with said first user, said first software application, and said first work type being performed by said first user;

analyzing, by said feedback software application, said first user functions with respect to said first profile;

generating in response to said analyzing said first user functions with respect to said first profile, by said feedback software application, a first analysis report comprising results of said analyzing said first user functions with respect to said first profile; and

presenting, by said computing system to said first user, said first analysis report.

The present invention provides a process for supporting computer infrastructure, said process comprising providing at least one support service for at least one of creating, integrating, hosting, maintaining, and deploying computer-readable code in a computing system, wherein the code in combination with the computing system is capable of performing a feedback method, said method comprising:

enabling, by said computing system for a first user, access to said computing system, wherein said computing system comprises a memory system, wherein said memory system comprises a first plurality of profiles, a feedback software application, and a plurality of software applications, and wherein each profile of said first plurality of profiles is associated with said first user and various types of work to be performed by said first user;

enabling, by said computing system, said feedback software application;

enabling, by said computing system, access to a first software application of said plurality of software applications;

retrieving, by said computing system from said memory system, a first profile of said first plurality of profiles, said first profile associated with said first software application, said first user, and a first work type, said first work type being performed by said first user;

monitoring, by said feedback software application, first user functions associated with said first user, said first software application, and said first work type being performed by said first user;

analyzing, by said feedback software application, said first user functions with respect to said first profile;

generating in response to said analyzing said first user functions with respect to said first profile, by said feedback software application, a first analysis report comprising results of said analyzing said first user functions with respect to said first profile; and presenting, by said computing system to said first user, said first analysis report.

The present invention advantageously provides a simple method and associated system capable of helping a user to create data objects.

### BRIEF DESCRIPTION OF THE DRAWINGS

FIG. 1 illustrates a feedback system for monitoring computer user functions for a user and providing feedback associated with the user functions, in accordance with embodiments of the present invention.

FIG. 2 illustrates a flowchart describing an example of an algorithm used by system of FIG. 1 for monitoring computer user functions for a user and providing feedback associated with the user functions, in accordance with embodiments of the present invention.

FIG. 3 illustrates a flowchart illustrating an algorithm for generating a profile, in accordance with embodiments of the present invention.

FIG. 4 illustrates a computer apparatus used for monitoring computer user functions for a user and providing feedback associated with the user functions, in accordance with embodiments of the present invention.

### DETAILED DESCRIPTION OF THE INVENTION

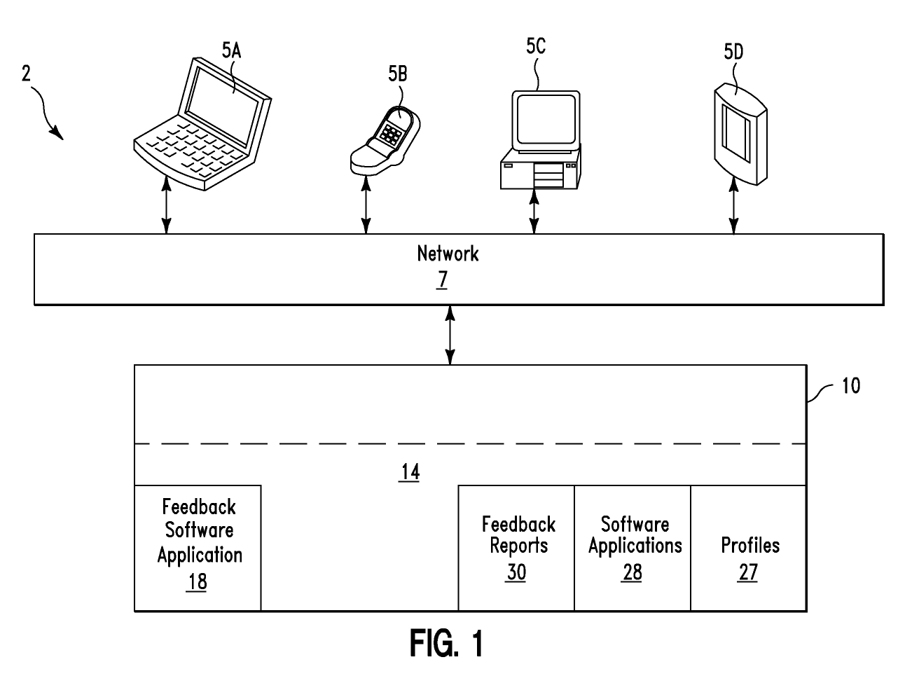

FIG. 1 illustrates a feedback system 2 for monitoring computer user functions for a user and providing feedback associated with the user functions, in accordance with embodiments of the present invention. The feedback (e.g., a feedback report) may comprise suggestions for the user to efficiently perform computer functions (e.g., using a word processor program, using a spreadsheet program, etc).

For example, system 2 could be used to monitor user keystrokes (i.e., on a keyboard) in order to recommend efficient options for using a software application (e.g., a word processor program). The following series of steps illustrate an example for monitoring user keystrokes on a keyboard:
1. A feedback software application 18 is enabled.
2. Feedback software application 18 monitors the speed of user keystrokes to determine how fast the user types words, finds different icons, finds different banner headings, etc.
3. Computing system 10 stores a sequence and frequency of keystrokes for analysis to determine which keystroke(s) could be: re-sequenced, replaced by existing macros, replaced by objects, replaced by newly created macros, or eliminated entirely.
4. Feedback software application 18 determines which options are not necessary or very infrequently used.
5. Feedback software application 18 analyzes the keystrokes after the current session has been completed and stores the results.
6. Feedback software application 18 compares the current session to previous sessions (i.e., if available) in order to check for pervasive patterns.
7. Feedback software application 18 presents the analysis from step 5 to the user (e.g., in the form of a feedback report). The feedback report comprises recommendations of more streamlined actions, education required, manuals to be used, etc. The recommendations would benefit the user specifically based on a type of work being performed by the user. The feedback report may additionally comprise recommendations of how a document, presentation, spreadsheet, etc could be enhanced by graphics, different fonts, etc.

System 2 of FIG. 1 comprises a plurality of input/output (I/O) devices 5A . . . 5D connected to a computing system 10 through a network 7. I/O devices5A . . . 5D may comprise any type of I/O device such as, inter alia, a notebook computer 5A, a cellular telephone 5B, a desktop computer 5C, a personal digital assistant (PDA) 5D, etc. Network 7 may comprise any type of network including, inter alia, a local area network, (LAN), a wide area network (WAN), the Internet, etc. Computing system 10 may comprise any type of computing system including, inter alia, a personal computer (PC), a server computer, a database computer, etc. Computing system 10 comprises a memory apparatus 14. Memory apparatus 14 comprises feedback software application 18, profiles 27, software applications 28, and feedback reports 30. Feedback software application 18 controls all functions related to:
1. Generating profiles 27.
2. Analyzing user functions (e.g., user keystrokes).
3. Generating feedback reports 30.

As an alternative, each of I/O devices 5A . . . 5D could each comprise a memory apparatus 14 comprising a feedback software application 18, profiles 27, software applications 28, and feedback reports 30, thereby eliminating a need for network 7 and computing system 10. The aforementioned configuration causes each of I/O devices to be independent from each other.

Software applications 28 may comprise any type of software applications including, inter alia, word processor programs, spreadsheet programs, Web based programs, etc. Each of profiles 27 comprises information associated with one of software applications 28, a specific user, and a type of work (e.g., general office computer input work, computer programming, database configuration, etc) being performed by the specific user.

Feedback software application 18 allows for the following functionality with respect to generating feedback reports:

Upon activation, feedback software application 18 identifies a user (i.e., using one of software applications 28 via one of I/O devices) and presents a few basic questions to the user. The questions may be associated with a type of document to be generated, a specific presentation for the document in terms of complexity, and a projected time frame for completion of work. Feedback software application 18 may request that the user provide a first signal if the work is being interrupted and a second signal when the interrupted work is being resumed. Feedback software application 18 generates a file comprising time stamped keystrokes. Using a preloaded dictionary (or a web accessed dictionary), feedback software application 18 may associate different patterns to different sequences (i.e., for the keystrokes). The associations allow for analysis by software application in order to find unnecessary or inefficient keystrokes sequences. Keystroke combinations may be analyzed for replacement by existing macros or newly created macros to replace the unnecessary or inefficient keystrokes sequences. Feedback software application 18 may optionally, create this macro and recommend a keystroke sequence to activate this macro. If many attempts at a particular action were attempted and deleted, feedback software application 18 may recommend manuals and/or education in this particular subject. If the user inputted particular manual(s) as part of profiling questions, feedback software application 18 may point to pages in these manual(s) which would help the user in this particular area. Feedback software application 18 may also monitor existing user options. For example, if feedback software application 18 determines that a spelling dictionary (e.g., in a word processing program) was activated but the user made very infrequent mistakes, feedback software application 18 may recommend that computer resources devoted to the spell checker be freed up by running one spell check at the very end. Feedback software application 18 may additionally recommend that a voice recognition program be used for very slow typing users. After a session has been formally ended by the user, feedback software application 18 may perform a self standing analysis or do an on-line analysis. This analysis may compare previous sessions to the current session and profile the current session in terms of:
1. User speed and accuracy.
2. Unnecessary keystrokes.

As a result of the analysis, feedback software application 18 may:
1. Recommended existing macros or macro to be created that would increase user efficiency in terms of time and accuracy.
2. Recommend education (e.g., if many attempts were made to create a diagram containing circles, this could be highlighted).
3. Analyze a type of session and make suggestions for enhancements. For example, feedback software application 18 may make recommendations in terms of document formatting (changing tabs/page margins) to enhance document presentation and readability by showing how the document looks with/without enhancements.
4. Recommend shortcuts to existing keystroke to improve productivity.
5. Create a sequence of control/macro actions executed (breadcrumbs) so that a user could recreate any steps executed.

The following description illustrates a feedback report generation process. Once a user enables (i.e., starts up) an office software application (e.g., word processing software, spreadsheet software, project plan software, presentation software, etc), feedback software application 18 performs a search for a profile for the user. A listing of available profiles is presented to the user. The listing of available profiles may comprise a short description for each profile or an option to create a new profile. Table 1 illustrates an example of a list of profiles.

TABLE 1

| Profile Name | Program | Description | Usage |
|---|---|---|---|
| Power | Word inputter | Power inputting | Pure text inputting |
| | | | from another |
| | | | document or notes |
| Janice | Word inputter | Janice's personal | Personalized profile |
| | | profile | for Janice in terms of |
| | | | speed, dictionaries, |
| | | | etc. |
| Medical | Word inputter | Medical input | Medical terms, |
| | | | names, dictionary |
| Legal | Word inputter | Legal input | Legal terms, names, |
| | | | dictionary, legal |
| | | | format, legal size |
| | | | paper defaults |
| Standard | Spreadsheet | Standard | Fixed format, |
| | | spreadsheet | autosave settings, free |
| | | | form structure |
| Financial | Spreadsheet | Spreadsheet | Defined financial |
| | | customized for | formatting ($ for US |
| | | financial input | currency, 2 decimal |
| | | | places, addition |
| | | | macros, |
| Standard | Presentation | Standard Office | Office template, spell |
| presentation | Graphics | | checking on |
| Legal | Presentation | Legal | Legal template |
| | Graphics | presentations | containing |
| | | | disclaimers in footer, |
| School | Presentation | Schoolwork | General presentation |
| | Graphics | presentation | template, spell |
| | | groups | checking, drawing |
| | | | tools |

If a profile doesn't exist (i.e., is not listed), then the user is prompted to generate a new profile comprising the following attributes:
1. Profile name
2. Profile description
3. Usage
4. Username
5. Type of User (e.g., advanced, intermediate, beginner, etc)
6. Suggestion prompting on/off
7. Spell checking on/off
8. Macro checking on/off
9. Macro creation on/off
10. Grammar checking on/off
11. Speed monitor on/off
12. Logging on/off
13. Grade level checking on/off (may be set for a specific grade level)

The user may be prompted to use available profiles already in existence or to modify an existing profile. For example, a slower typist performing legal input work might modify/personalize an existing legal profile or an existing user profile to substitute a legal dictionary, legal form size, legal format, etc. The user continues generating a document type corresponding to the software application in use. Additionally, session specific changes may be made to the profile. Session specific changes may include, inter alia, using or adding a different dictionary (US vs. UK, legal, medical, etc.), toggling certain profile features for this session only, etc.

After the profile is selected modified, or generated, software application 18 performs an analysis. If the spell check feature is enabled in the software application being used, then spelling mistakes including auto corrections are counted. Depending on a threshold (i.e., from the profile) for the type of user, feedback software application 18 may suggest that the auto spellchecker be turned off if fewer mistakes are found or conversely, turned on if more mistakes are made as input is generated. Feedback software application 18 measures words per minute (WPM) (counting words and timing the count) and displays the current WPM in a window on a monitor. Audible tones may be set and generated depending on WPM. Additionally, feedback software application 18 may measure spelling mistales per words typed and compare the measurement to a threshold in the profile. If the threshold is exceeded by a given percentage (e.g., 10%), a popup window could appear to suggest turning the spellchecker on or off depending on which way the threshold was exceeded. The popup window could be set to disappear after a given amount of time (e.g., 5 seconds). Similarly, software application 18 could measure a predetermined number of keystrokes/inputs (e.g., 5) that were not letters or punctuation. For example, a manual table creation with a specified number of rows and columns. If this was repeated more than 2 times in a session, software application 18 would combine the keystrokes and store this as a potential macro.

After a work session is completed (e.g., signaled by the user that the session analysis should begin), feedback software application 18 may ask the user if an analysis session should be started. The analysis session could comprise the following:
1. Speed monitor recording time/keystrokes to evaluate if the type of user is appropriate. For example: 0-15 words/minute could categorize a beginner user, 16-35 words/minute could categorize an intermediate use, 36 and above words/minute could categorize an advanced user.
2. Repetitive keystrokes, stored as part of a logging function, would prompt a request to the user to determine if a macro should be created, what its name should be, and whether it should be a private or publicly available macro. Feedback software application 18 would then create the macro.
3. The file would be examined for font usage, style formatting (should this be one page, two pages, etc.), template usage, etc. using given word or presentation graphics available templates. Suggestions could be made regarding formatting, font size, etc. if a desired page count is to be achieved. Similarly a word count could be specified and an alarm triggered if that count is exceeded. Additionally, spreadsheets could be examined for formatting (two decimal point formatting where all of the numbers are all integers) and appropriate changes suggested.
4. The file would also be examined for forward/backward actions indicative of executed actions followed by undoing the executed action. This would prompt the profile to recommend education on various topics. For example, if the user was repeatedly generating a chart using straight lines, and circles, this topic could be highlighted for further education, and if requested, do a simple lookup of published materials.
5. Upon completion, feedback software application 18 could run a comparison of the session versus previous sessions on the same profile. This results in the generation of charts illustrating speed comparison differences, accuracy comparisons, as well as proficiency comparisons (e.g., a time required for generating one chart). Suggestions could be made by software application 18 as to how the user could upgrade the profile level (e.g., typing tutorial based on frequent forward/reverse typing), how to perform easier spreadsheet data entry (e.g., entering months one at a time vs. employing an existing macro that does it at one time), how to generate graphs in a more efficient manner, etc. Additionally, all of these programs could be linked to websites that contain help, suggestions, or additional templates.

The following description (steps) illustrates an example of implementation for monitoring computer user functions for a user and providing feedback associated with the user functions:

Janice, (i.e., a user) logs on to her computing system in order to perform work using a word inputting (processing) program. She selects the word inputting program and is prompted to select a profile from her previously saved profiles, system defined profiles, or creation of a new profile. Additionally, Janice is prompted as to whether previous statistics/history should be loaded for processing during/after her present session. Janis selects a profile (e.g., Janice from chart 1) which describes her as an intermediate user. As result of the profile, a standard and supplemental dictionary and spell and grammar checking are loaded. Various defaults of margins and print options are additionally loaded. Janice request that a profiling analysis be turned on. Janis generates and completes a first document, modifies a second document, etc. Upon signaling (i.e., by Janis) that a session is complete, feedback software application 18 notes that although Janis preloaded the spell checker feature, she only made one spelling mistake. Feedback software application 18 suggests that the profile should be changed so that the spell checker feature will not be loaded in future sessions and that Janis should merely check (i.e., for spelling) the document when she has completed it. Additionally, any typing statistics (words/minute, spelling mistakes, grammar mistakes, etc) would be updated in the profile. Any hesitancy in typing (such as numbers) is noted and recommendations are made to practice these characters. Additionally, any repetitive actions, (e.g., invoking the table creation program, indexing, table of contents creation, etc) within this is stated and Janice is prompted to have these repetitive actions added to the profile.

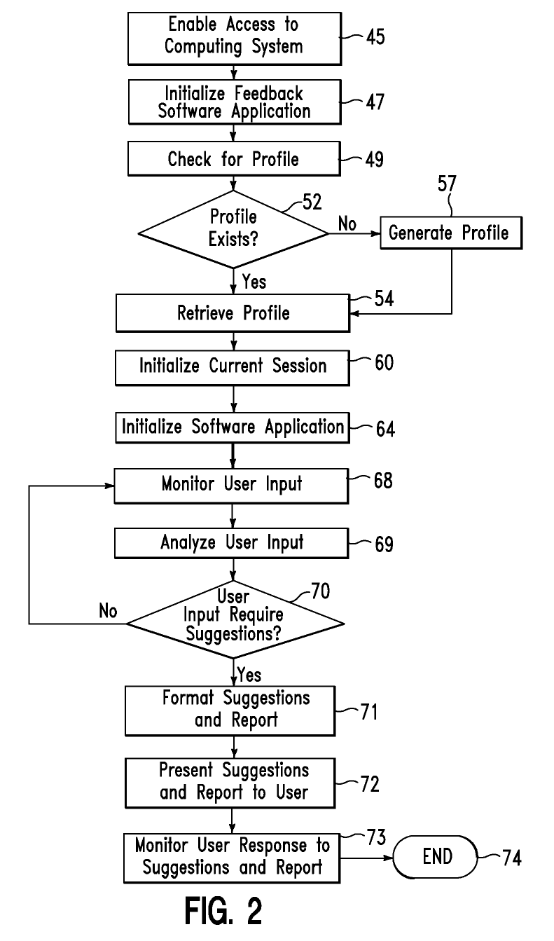

FIG. 2 illustrates a flowchart describing an example of an algorithm used by system 2 of FIG. 1 for monitoring computer user functions for a user and providing feedback associated with the user functions, in accordance with embodiments of the present invention. In step 45, a user logs into computing system 10 and is granted access. In step 47, computing system initializes feedback software application 18. In step 49, feedback software application 18 (in response to user request) checks memory system for profiles associated with the user, a type of work being performed by the user, and/or a type of software application to be used by the user. In step 52, it is determined if a requested profile is available.

If in step 52, it is determined that the requested profile is not available then in step 57 a profile generation process is performed as described with reference to FIG. 1, supra and step 54 is executed as described, supra. The profile may be stored in memory system 14.

If in step 52, it is determined that the requested profile is available then in step 54 the requested profile is retrieved from memory system 14. In step 60, a current feedback session is initialized for the user. In step 64, a software application to be used by the user (e.g., a word processing software application) is initialized. In step 68, feedback software application 18 monitors user input and functions as described with reference to FIG. 1. In step 69, the user input and functions are analyzed. The user input and functions are analyzed with respect to the user profile retrieved in step 54, a user profile for another user, past user input, etc. In step 70, it is determined if the user input analyzed in step 69 requires suggestions for performing functions efficiently.

If in step 70, it is determined that the user input analyzed in step 69 does not require suggestions for performing functions efficiently then step 68 is repeated.

If in step 70, it is determined that the user input analyzed in step 69 does require suggestions for performing functions efficiently then in step 71 suggestions are formatted and a feedback report is generated. In step 72, the feedback report is presented to the user. In step 73, feedback software application monitors user response to the suggestions and the process terminates in step 74.

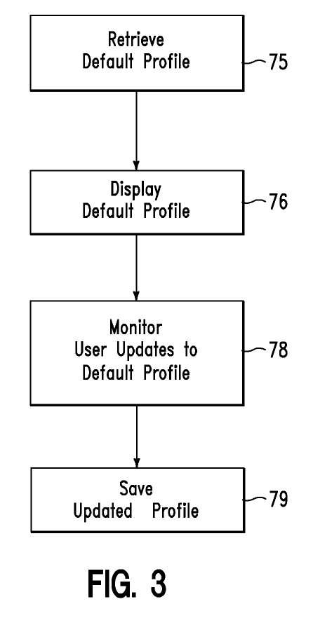

FIG. 3 illustrates a flowchart detailing step 57 of FIG. 2 for generating a profile, in accordance with embodiments of the present invention. In step 75, a default (i.e., generic) profile is retrieved. The generic profile may comprise a profile template. In step 76, the default (i.e., generic) profile is presented to the user. In step 78, the user updates the profile and feedback software application 18 monitors the updates to the profile. In step 79, the profile is named and saved.

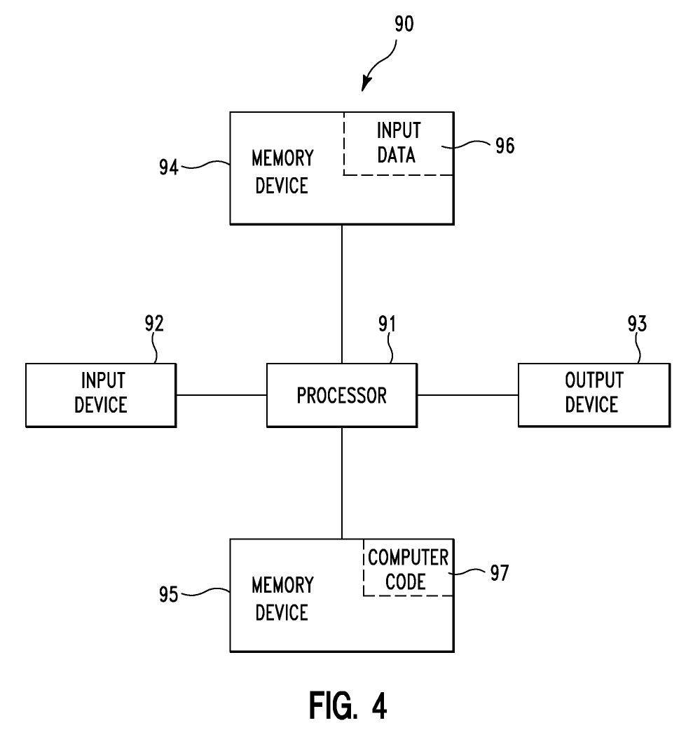

FIG. 4 illustrates a computer apparatus 90 (e.g., computing system 10 of FIG. 1) used for monitoring computer user functions for a user and providing feedback associated with the user functions, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithms of FIGS. 2-3) for monitoring computer user functions for a user and providing feedback associated with the user functions. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 4) may comprise the algorithms of FIGS. 2-3 and may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise said computer usable medium (or said program storage device).

Still yet, any of the components of the present invention could be created, integrated, hosted, maintained, deployed, managed, serviced, etc. by a service provider who offers to monitor computer user functions for a user and provide feedback associated with the user functions. Thus the present invention discloses a process for deploying, creating, integrating, hosting, maintaining, and/or integrating computing infrastructure, comprising integrating computer-readable code into the computer system 90, wherein the code in combination with the computer system 90 is capable of performing a method for monitoring computer user functions for a user and providing feedback associated with the user functions. In another embodiment, the invention provides a business method that performs the process steps of the invention on a subscription, advertising, and/or fee basis. That is, a service provider, such as a Solution Integrator, could offer to monitor computer user functions for a user and provide feedback associated with the user functions. In this case, the service provider can create, maintain, support, etc. a computer infrastructure that performs the process steps of the invention for one or more customers. In return, the service provider can receive payment from the customer(s) under a subscription and/or fee agreement and/or the service provider can receive payment from the sale of advertising content to one or more third parties.

While FIG. 4 shows the computer system 90 as a particular configuration of hardware and software, any configuration of hardware and software, as would be known to a person of ordinary skill in the art, may be utilized for the purposes stated supra in conjunction with the particular computer system 90 of FIG. 4. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A feedback method comprising:
enabling, by a computing system for a first user, access to said computing system, wherein said computing system comprises a memory system, wherein said memory system comprises a first plurality of profiles, a feedback software application, and a plurality of software applications, and wherein each profile of said first plurality of profiles is associated with said first user and various types of work to be performed by said first user;
enabling, by said computing system, said feedback software application;
enabling, by said computing system, access to a first software application of said plurality of software applications;
retrieving, by said computing system from said memory system, a first profile of said first plurality of profiles, said first profile associated with said first software application, said first user, and a first work type, said first work type being performed by said first user;
monitoring, by said feedback software application, first user functions associated with said first user, said first software application, and said first work type being performed by said first user;
analyzing, by said feedback software application, said first user functions with respect to said first profile;
generating in response to said analyzing said first user functions with respect to said first profile, by said feedback software application, a first analysis report comprising results of said analyzing said first user functions with respect to said first profile; and
presenting, by said computing system to said first user, said first analysis report.

2. The method of claim 1, wherein said method further comprises:
enabling, by said computing system for a second user, access to said computing system, wherein said memory system comprises a second plurality of profiles, and wherein each profile of said second plurality of profiles is associated with said second user and various types of work to be performed by said second user;
enabling, by said computing system for said second user, access to said first software application;
retrieving, by said computing system from said memory system, a second profile of said second plurality of profiles, said second profile associated with said first software application, said second user, and said first work type, said first work type being performed by said second user;
monitoring, by said feedback software application, second user functions associated with said second user, said first software application, and said first work type being performed by said second user;
analyzing, by said feedback software application, said second user functions with respect to said second profile;
generating in response to said analyzing said second user functions with respect to said second profile, by said feedback software application, a second analysis report comprising results of said analyzing said second user functions with respect to said second profile; and
presenting, by said computing system to said second user, said second analysis report.

3. The method of claim 2, further comprising:
analyzing, by said feedback software application, said second user functions with respect to said first user functions;
generating in response to said analyzing said second user functions with respect to said first user functions, by said feedback software application, a third analysis report comprising results of said analyzing said second user functions with respect to said first user functions; and
presenting, by said computing system to said second user, said third analysis report.

4. The method of claim 1, wherein said first user functions comprise input functions associated with keyboard usage.

5. The method of claim 1, wherein said first analysis report comprises suggestions for said first user, said suggestions comprising efficiency ideas for: performing said first user functions, using said first software application, and performing said first type of work.

6. The method of claim 1, further comprising:
enabling, by said computing system, access to a second software application of said plurality of software applications, said second software application differing from said first software application;
retrieving, by said computing system from said memory system, a second profile of said first plurality of profiles, said second profile associated with said second software application, said first user, and a second work type, said second work type being performed by said first user;
monitoring, by said feedback software application, second user functions associated with said first user, said second software application, and said second work type being performed by said first user;
analyzing, by said feedback software application, said second user functions with respect to said second profile;
generating in response to said analyzing said second user functions with respect to said second profile, by said feedback software application, a second analysis report comprising results of said analyzing said second user functions with respect to said second profile; and
presenting, by said computing system to said first user, said second analysis report.

7. A computing system comprising a processor coupled to a computer-readable memory unit, said memory unit comprising a first plurality of profiles, a feedback software application, a plurality of software applications, and instructions that when executed by the processor implement a feedback method, each profile of said first plurality of profiles associated with a first user and various types of work to be performed by said first user, said method comprising:
enabling, by said computing system for said first user, access to said computing system;
enabling, by said computing system, said feedback software application;
enabling, by said computing system, access to a first software application of said plurality of software applications;
retrieving, by said computing system from said memory system, a first profile of said first plurality of profiles, said first profile associated with said first software application, said first user, and a first work type, said first work type being performed by said first user;
monitoring, by said feedback software application, first user functions associated with said first user, said first software application, and said first work type being performed by said first user;
analyzing, by said feedback software application, said first user functions with respect to said first profile;
generating in response to said analyzing said first user functions with respect to said first profile, by said feedback software application, a first analysis report comprising results of said analyzing said first user functions with respect to said first profile; and
presenting, by said computing system to said first user, said first analysis report.

8. The computing system of claim 7, wherein said computer-readable memory unit further comprises a second plurality of profiles, wherein each profile of said second plurality of profiles is associated with said second user and various types of work to be performed by said second user, and wherein said method further comprises:
enabling, by said computing system for said second user, access to said computing system;
enabling, by said computing system for said second user, access to said first software application;
retrieving, by said computing system from said computer-readable memory unit, a second profile of said second plurality of profiles, said second profile associated with said first software application, said second user, and said first work type, said first work type being performed by said second user;
monitoring, by said feedback software application, second user functions associated with said second user, said first software application, and said first work type being performed by said second user;
analyzing, by said feedback software application, said second user functions with respect to said second profile;
generating in response to said analyzing said second user functions with respect to said second profile, by said feedback software application, a second analysis report comprising results of said analyzing said second user functions with respect to said second profile; and
presenting, by said computing system to said second user, said second analysis report.

9. The computing system of claim 8, wherein said method further comprises:
analyzing, by said feedback software application, said second user functions with respect to said first user functions;
generating in response to said analyzing said second user functions with respect to said first user functions, by said feedback software application, a third analysis report comprising results of said analyzing said second user functions with respect to said first user functions; and
presenting, by said computing system to said second user, said third analysis report.

10. The computing system of claim 7, wherein said first user functions comprise input functions associated with keyboard usage.

11. The computing system of claim 7, wherein said first analysis report comprises suggestions for said first user, said suggestions comprising efficiency ideas for: performing said first user functions, using said first software application, and performing said first type of work.

12. The computing system of claim 7, wherein said method further comprises:
enabling, by said computing system, access to a second software application of said plurality of software applications, said second software application differing from said first software application;
retrieving, by said computing system from said computer-readable memory unit, a second profile of said first plurality of profiles, said second profile associated with said second software application, said first user, and a second work type, said second work type being performed by said first user;
monitoring, by said feedback software application, second user functions associated with said first user, said second software application, and said second work type being performed by said first user;
analyzing, by said feedback software application, said second user functions with respect to said second profile;
generating in response to said analyzing said second user functions with respect to said second profile, by said feedback software application, a second analysis report comprising results of said analyzing said second user functions with respect to said second profile; and
presenting, by said computing system to said first user, said second analysis report.

13. A computer program product, comprising a computer readable medium comprising a computer readable program code embodied therein, said computer readable program code adapted to implement a feedback method within a computing system, said method comprising:
enabling, by said computing system for a first user, access to said computing system, wherein said computing system comprises a memory system, wherein said memory system comprises a first plurality of profiles, a feedback software application, and a plurality of software applications, and wherein each profile of said first plurality of profiles is associated with said first user and various types of work to be performed by said first user;
enabling, by said computing system, said feedback software application;
enabling, by said computing system, access to a first software application of said plurality of software applications;
retrieving, by said computing system from said memory system, a first profile of said first plurality of profiles, said first profile associated with said first software application, said first user, and a first work type, said first work type being performed by said first user;
monitoring, by said feedback software application, first user functions associated with said first user, said first software application, and said first work type being performed by said first user;
analyzing, by said feedback software application, said first user functions with respect to said first profile;
generating in response to said analyzing said first user functions with respect to said first profile, by said feedback software application, a first analysis report comprising results of said analyzing said first user functions with respect to said first profile; and
presenting, by said computing system to said first user, said first analysis report.

14. The computer program product of claim 13, wherein said memory system further comprises a second plurality of profiles, wherein each profile of said second plurality of profiles is associated with said second user and various types of work to be performed by said second user, and wherein said method further comprises:
enabling, by said computing system for said second user, access to said computing system;
enabling, by said computing system for said second user, access to said first software application;
retrieving, by said computing system from said memory system, a second profile of said second plurality of profiles, said second profile associated with said first software application, said second user, and said first work type, said first work type being performed by said second user;
monitoring, by said feedback software application, second user functions associated with said second user, said first software application, and said first work type being performed by said second user;
analyzing, by said feedback software application, said second user functions with respect to said second profile;
generating in response to said analyzing said second user functions with respect to said second profile, by said feedback software application, a second analysis report comprising results of said analyzing said second user functions with respect to said second profile; and
presenting, by said computing system to said second user, said second analysis report.

15. The computer program product of claim 14, wherein said method farther comprises:
analyzing, by said feedback software application, said second user functions with respect to said first user functions;
generating in response to said analyzing said second user functions with respect to said first user functions, by said feedback software application, a third analysis report comprising results of said analyzing said second user functions with respect to said first user functions; and
presenting, by said computing system to said second user, said third analysis report.

16. The computer program product of claim 13, wherein said first user functions comprise input functions associated with keyboard usage.

17. The computer program product of claim 13, wherein said first analysis report comprises suggestions for said first user, said suggestions comprising efficiency ideas for: performing said first user functions, using said first software application, and performing said first type of work.

18. The computer program product of claim 13, wherein said method further comprises:
enabling, by said computing system, access to a second software application of said plurality of software applications, said second software application differing from said first software application;
retrieving, by said computing system from said memory system, a second profile of said first plurality of profiles, said second profile associated with said second software application, said first user, and a second work type, said second work type being performed by said first user;
monitoring, by said feedback software application, second user functions associated with said first user, said second software application, and said second work type being performed by said first user;
analyzing, by said feedback software application, said second user functions with respect to said second profile;
generating in response to said analyzing said second user functions with respect to said second profile, by said feedback software application, a second analysis report comprising results of said analyzing said second user functions with respect to said second profile; and
presenting, by said computing system to said first user, said second analysis report.

19. A process for supporting computer infrastructure, said process comprising providing at least one support service for at least one of creating, integrating, hosting, maintaining, and deploying computer-readable code in a computing system, wherein the code in combination with the computing system is capable of performing a feedback method, said method comprising:
enabling, by said computing system for a first user, access to said computing system, wherein said computing system comprises a memory system, wherein said memory system comprises a first plurality of profiles, a feedback software application, and a plurality of software applications, and wherein each profile of said first plurality of profiles is associated with said first user and various types of work to be performed by said first user;
enabling, by said computing system, said feedback software application;
enabling, by said computing system, access to a first software application of said plurality of software applications;
retrieving, by said computing system from said memory system, a first profile of said first plurality of profiles, said first profile associated with said first software application, said first user, and a first work type, said first work type being performed by said first user;
monitoring, by said feedback software application, first user functions associated with said first user, said first software application, and said first work type being performed by said first user;
analyzing, by said feedback software application, said first user functions with respect to said first profile;
generating in response to said analyzing said first user functions with respect to said first profile, by said feedback software application, a first analysis report comprising results of said analyzing said first user functions with respect to said first profile; and
presenting, by said computing system to said first user, said first analysis report.

20. The process of claim 19, wherein said memory system further comprises a second plurality of profiles, wherein each profile of said second plurality of profiles is associated with said second user and various types of work to be performed by said second user, and wherein said method further comprises:
enabling, by said computing system for said second user, access to said computing system;
enabling, by said computing system for said second user, access to said first software application;
retrieving, by said computing system from said memory system, a second profile of said second plurality of profiles, said second profile associated with said first software application, said second user, and said first work type, said first work type being performed by said second user;
monitoring, by said feedback software application, second user functions associated with said second user, said first software application, and said first work type being performed by said second user;
analyzing, by said feedback software application, said second user functions with respect to said second profile;
generating in response to said analyzing said second user functions with respect to said second profile, by said feedback software application, a second analysis report comprising results of said analyzing said second user functions with respect to said second profile; and
presenting, by said computing system to said second user, said second analysis report.

21. The process of claim 20, wherein said method further comprises:
analyzing, by said feedback software application, said second user functions with respect to said first user functions;
generating in response to said analyzing said second user functions with respect to said first user functions, by said feedback software application, a third analysis report comprising results of said analyzing said second user functions with respect to said first user functions; and
presenting, by said computing system to said second user, said third analysis report.

22. The process of claim 19, wherein said first user functions comprise input functions associated with keyboard usage.

23. The process of claim 19, wherein said first analysis report comprises suggestions for said first user, said suggestions comprising efficiency ideas for: performing said first user functions, using said first software application, and performing said first type of work.

24. The process of claim 19, wherein said method further comprises:
enabling, by said computing system, access to a second software application of said plurality of software applications, said second software application differing from said first software application;
retrieving, by said computing system from said memory system, a second profile of said first plurality of profiles, said second profile associated with said second software application, said first user, and a second work type, said second work type being performed by said first user;
monitoring, by said feedback software application, second user functions associated with said first user, said second software application, and said second work type being performed by said first user;
analyzing, by said feedback software application, said second user functions with respect to said second profile;
generating in response to said analyzing said second user functions with respect to said second profile, by said feedback software application, a second analysis report comprising results of said analyzing said second user functions with respect to said second profile; and
presenting, by said computing system to said first user, said second analysis report.
